(19) United States
(12) Patent Application Publication
(10) Pub. No.: US 2021/0103191 A1
(43) Pub. Date: Apr. 8, 2021

(54) ARRAY SUBSTRATE FOR LIQUID CRYSTAL DISPLAY, MANUFACTURING METHOD FOR THE SAME AND LIQUID CRYSTAL DISPLAY

(71) Applicant: SHENZHEN CHINA STAR OPTOELECTRONICS TECHNOLOGY CO., LTD., Shenzhen, Guangdong (CN)

(72) Inventor: Wenbo LIU, Shenzhen, Guangdong (CN)

(21) Appl. No.: 16/079,200

(22) PCT Filed: Jul. 16, 2018
(86) PCT No.: PCT/CN2018/095767

§ 371 Date: Aug. 23, 2018

(30) Foreign Application Priority Data
May 18, 2018 (CN) 201810482956.8

(51) Int. Cl. G02F 1/1362; G02F 1/1368; G02F 1/1343; G02F 1/1335

(52) U.S. Cl. CPC G02F 1/136222; G02F 1/1368; G02F 2201/123; G02F 1/136209; G02F 1/133514; G02F 1/13439

(57) ABSTRACT

An array substrate for a liquid crystal display is disclosed. The array substrate includes: a substrate including multiple pixel portions; multiple thin-film transistors disposed in the pixel portions; multiple color filters, and the color filter is disposed in the pixel portion, wherein the multiple color filters includes a transparent color filter and/or a white color filter, colors of the transparent color filter and the white color filter are changed to a first color when a voltage is applied, and the first color is different from the other color filters except the transparent color filters and the white color filters in the multiple color filters; multiple transparent electrodes deposed between the transparent color filters and/or the white color filters and the pixel portions; and multiple pixel electrodes connected to the multiple thin-film transistors. The present invention can increase the color gamut range of the liquid crystal display.

### FIELD OF THE INVENTION

The present invention relates to a liquid crystal display technology field, and more particularly to an array substrate for liquid crystal display, manufacturing method for the same and liquid crystal display.

### BACKGROUND OF THE INVENTION

With the evolution of optoelectronics and semiconductor technology, the flat panel display has also greatly developed. Among many flat panel displays, the liquid crystal display (LCD) has many advantages such as high space utilization efficiency and low power consumption, no radiation and low electromagnetic interference so that the LCD has been applied to all aspects of production and life.

With the continuous improvement of the display requirements of the liquid crystal display, a large number of mainstream liquid crystal displays support more than 90% of the color gamut of NTSC, and some even reach 97% of NTSC, which is the wide color gamut liquid crystal display. Currently, the methods for major manufacturers to increase the color gamut of liquid crystal display mainly include increasing the number of primary colors (i.e., increasing the type of color filters) or switching to more advanced backlight technologies and the purpose of the present invention is to provide a new method for improving the color gamut of a liquid crystal display.

### SUMMARY OF THE INVENTION

In order to achieve the above object, the present invention provides an array substrate for a liquid crystal display, a manufacturing method for the same, and a liquid crystal display.

According to an aspect of the present invention, providing an array substrate for a liquid crystal display, wherein the array substrate comprises: a substrate including multiple pixel portions; multiple thin-film transistors disposed in the pixel portions; multiple color filters, and the color filter is disposed in the pixel portion, wherein the multiple color filters includes a transparent color filter and/or a white color filter, colors of the transparent color filter and the white color filter are changed to a first color when a voltage is applied, and the first color is different from the other color filters except the transparent color filters and the white color filters in the multiple color filters; multiple transparent electrodes deposed between the transparent color filters and/or the white color filters and the pixel portions; and multiple pixel electrodes connected to the multiple thin-film transistors.

Furthermore, the array substrate further includes a black matrix located on the thin-film transistor and disposed between the color filters.

According to an aspect of the present invention, providing a manufacturing method for array substrate of liquid crystal display, comprising steps of: forming multiple thin-film transistors on multiple pixel portions of a substrate; forming multiple transparent electrodes on the multiple pixel portions; forming multiple color filters on the multiple pixel portions, wherein the multiple color filters includes a transparent color filter and/or a white color filter, colors of the transparent color filter and the white color filter are changed to a first color when a voltage is applied, and the first color is different from the other color filters except the transparent color filters and the white color filters in the multiple color filters; and forming a pixel electrode connected to the thin-film transistor on the multiple filters.

Furthermore, the multiple color filters further include a red color filter, a green color filter and a blue color filter.

Furthermore, the first color is yellow or cyan.

Furthermore, the manufacturing method further comprises a step of forming a black matrix on the thin-film transistor between the color filters.

According to an aspect of the present invention, providing a liquid crystal display comprising the above array substrate.

The beneficial effects of the invention: The present invention changes the color of the white color filter and/or the transparent color filter made of an electrochromic material by applying a voltage to increase the color gamut range of the liquid crystal display.

### BRIEF DESCRIPTION OF THE DRAWINGS

Through following description combining with drawings, the above and other aspects, features and advantages of the embodiments of the present invention will become more apparent. In the drawings:

FIG. 1 is a simplified plan view of an array substrate for a liquid crystal display according to an embodiment of the present invention.

FIG. 2 is a side view of an array substrate for a liquid crystal display according to an embodiment of the present invention.

FIG. 3 is another side view of an array substrate for a liquid crystal display according to an embodiment of the present invention.

FIG. 4 is a flow chart of a manufacturing method for an array substrate of a liquid crystal display according to an embodiment of the present invention.

### DETAILED DESCRIPTION OF PREFERRED EMBODIMENTS

Hereinafter, embodiments of the present invention will be described in detail with reference to the accompanying drawings. However, the invention may be embodied in many different forms and the invention should not be construed as being limited to the specific embodiments set forth herein. Rather, the embodiments are provided to explain the principles of the invention and its application, so that those skilled in the art can understand various embodiments of the invention and various modifications that are suitable for the particular intended application.

In the drawings, the thickness of layers and regions are exaggerated for clarity. The same reference numerals used throughout the specification and the drawings represent the same device element.

In order to avoid the influence of the deviation to the aperture ratio of the liquid crystal display and the phenomenon of light leakage when the array substrate and the color film substrate are aligned and assembled, the color filter on Array (COA) integrated with the filter substrate and the array substrate is applied. The COA technology is to place the color filter on the array substrate.

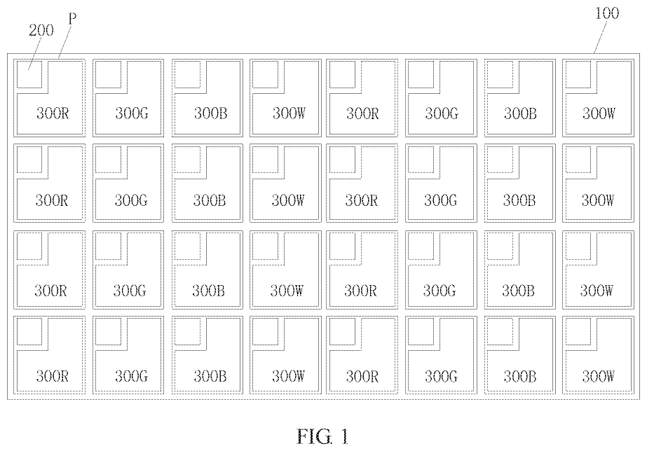

FIG. 1 is a simplified top plan view of an array substrate for a liquid crystal display according to an embodiment of the present invention. In FIG. 1, the number and positional relationship of a thin-film transistor, a pixel portion, and a color filter are mainly shown.

Referring to FIG. 1, an array substrate for a liquid crystal display according to an embodiment of the present invention includes a substrate 100, multiple thin-film transistors 200, and multiple color filters.

Specifically, the substrate 100 is divided into multiple pixel portions P. Preferably, the multiple pixel portions P are arranged in as a matrix, but the present invention is not limited thereto. The thin-film transistors 200 are disposed in the pixel portions 100. Preferably, each pixel portion P is provided with one thin-film transistor 200, but the present invention is not limited thereto. Furthermore, the thin-film transistor 200 is located at a corner region of the pixel portion P, but the present invention is not limited thereto.

The color filter is disposed in the pixel portion 100. Preferably, each pixel portion P is provided with one color filter, but the present invention is not limited thereto. Furthermore, the color filter is located in a region of the pixel portion P that is not occupied by the thin-film transistor 200; that is, the color filter and the thin-film transistor 200 are independent with each other and do not overlap, but the present invention is not limited thereto, for example, the color filter may also be partially overlapped with the thin-film transistor 200.

The multiple color filters include a red color filter 300R, a green color filter 300G, a blue color filter 300B, and a white color filter 300W. Preferably, the numbers of the red color filter 300R, the green color filter 3000, the blue color filter 300B and the white color filter 300W are the same. As another embodiment of the present invention, all of the white color filters 300W can be replaced by transparent color filters. Alternatively, as still another embodiment of the present invention, a portion of the white color filters 300W is replaced by transparent color filters. Accordingly, the multiple filters include a red color filter 300R, a green color filter 300G, a blue color filter 300B, a white color filter 300W and transparent color filter.

In the present embodiment, the white color filter 300W is made of an electrochromic material such that after the white color filter 300W is applied with a voltage, the color of the white color filter 300W is changed to a first color, and the first color is different from the red color filter 300R, the green color filter 300G, and the blue color filter 300B, and is also not transparent. Preferably, in the present embodiment, the first color may be, for example, yellow or cyan, but the invention is not limited thereto.

In addition, after the white color filter 300W is completely replaced by the transparent color filter, the transparent color filter is also made of an electrochromic material, so that after the transparent color filter is applied with a voltage, the color of the transparent color filter changes to the first color, and the first color is different from the red color filter 300R, the green color filter 300G, and the blue color filter 300B, and is also not white.

Furthermore, after a portion of the white color filters 300W are replaced by transparent color filters, each of the white color filters 300W and the transparent color filters are both made of an electrochromic material, such that after the white color filter 300W and the transparent color filter is applied with a voltage, the colors of the white color filter 300W and the transparent color filter are changed to the first color, and the first color is different from the red color filter 300R, the green color filter 300G, and the blue color filter 300B, and the colors are not white and not transparent.

Thus, the present invention changes the color of a white color filter and/or a transparent color filter made of an electrochromic material by applying a voltage to increase the color gamut range of the liquid crystal display.

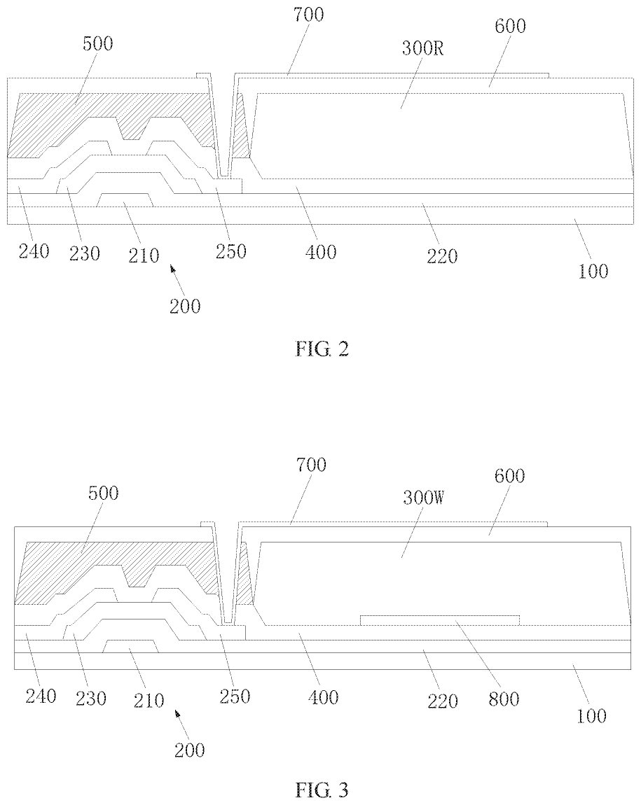

FIG. 2 is a side view of an array substrate for a liquid crystal display according to an embodiment of the present invention. In FIG. 2, the structures of the red color filter 300R and the thin-film transistor 200 are shown. It should be understood that the structures of the green color filter 300G and the blue color filter 300B are the same as the red color filter 300R.

Referring to FIG. 2, an array substrate for a liquid crystal display according to an embodiment of the present invention further includes a first passivation layer 400, a black matrix 500, a second passivation layer 600, and a pixel electrode 700.

Specifically, the thin-film transistor 200 includes a gate electrode 210, a gate insulation layer 220, an active layer 230, a source electrode 240, and a drain electrode 250. A first passivation layer 400 covers the thin-film transistor 200 and a region of the pixel portion P that are not occupied by the thin-film transistor 200. The red color filter 300R is disposed on the first passivation layer 400 located on a region of the pixel portion P that are not occupied by the thin-film transistor 200; further, the red color filter 300R is disposed on the first passivation layer 400 located on a region of the pixel portion P not occupied by the thin-film transistor 200. Here, the red color filter 300R and the thin-film transistor 200 are independent with each other and do not be overlapped.

The black matrix 500 is disposed on the first passivation layer 400 located on the thin-film transistor 200. That is, the black matrix 500 is disposed on a side of the filter (i.e., between adjacent filters) and above the thin-film transistor 200. As another embodiment of the present invention, the array substrate may not include the black matrix 500, and the black matrix is disposed on the color filter substrate opposite to the array substrate, and the black matrix on the color filter substrate is directly opposite to the thin-film transistor 200.

The second passivation layer 600 is disposed on the black matrix 500 and the red color filter 300R. The pixel electrode 700 is disposed on the second passivation layer 600, and the pixel electrode 700 sequentially penetrates the second passivation layer 600, the black matrix 500, and the first passivation layer 400 to be connected to the drain electrode 250 of the thin-film transistor 200.

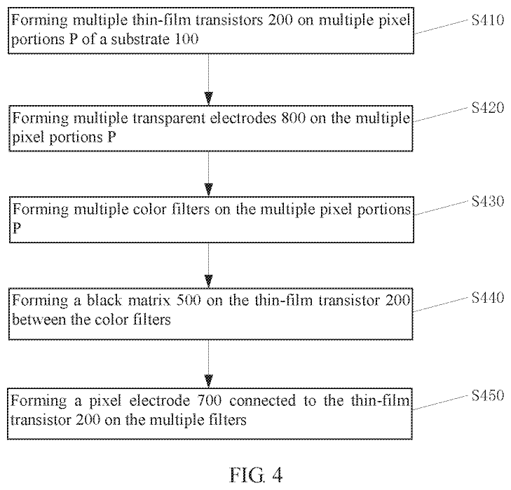

FIG. 3 is another side view of an array substrate for a liquid crystal display according to an embodiment of the present invention. In FIG. 3, the structures of the white color filter 300W and the thin-film transistor 200 are shown. It should be understood that if the white color filter 300W is replaced in whole or in part by the transparent color filter, the structure of the transparent color filter is the same as that of the white color filter 300W.

Referring to FIG. 3, an array substrate for a liquid crystal display according to an embodiment of the present invention further includes a transparent electrode 800.

Specifically, as described above, the thin-film transistor 200 includes a gate electrode 210, a gate insulation layer 220, an active layer 230, an ohmic contact layer 240, a source electrode 240, and a drain electrode 250. The first passivation layer 400 covers the thin-film transistor 200 and a region of the pixel portion P that are not occupied by the thin-film transistor 200. The transparent electrode 800 is disposed on the first passivation layer 400. Furthermore, the transparent electrode 800 is disposed on the first passivation layer 400 located on a region of the pixel portion P not occupied by the thin-film transistor 200. The white color filter 300W is disposed on the first passivation layer 400 and the transparent electrode 800; furthermore, the white color filter 300W is disposed on the transparent electrode 800 and on the first passivation layer 400 located on a region of the pixel portion P not occupied by the thin-film transistor 200. Here, the white color filter 300W and the thin-film transistor 200 are independent with each other and do not overlap.

The black matrix 500 is disposed on the first passivation layer 400 located on the thin-film transistor 200. That is, the black matrix 500 is disposed on a side of the filter (i.e., between adjacent filters) and above the thin-film transistor 200. As another embodiment of the present invention, the array substrate may not include the black matrix 500, and the black matrix is disposed on the color filter substrate opposite to the array substrate, and the black matrix on the color filter substrate is directly opposite to the thin-film transistor 200.

The second passivation layer 600 is disposed on the black matrix 500 and the white color filter 300W. The pixel electrode 700 is disposed on the second passivation layer 600, and the pixel electrode 700 sequentially penetrates the second passivation layer 600, the black matrix 500, and the first passivation layer 400 to be connected to the drain electrode 250 of the thin-film transistor 200.

FIG. 4 is a flow chart of a manufacturing method for array substrate of liquid crystal display according to an embodiment of the present invention.

Referring to FIG. 4, manufacturing method for array substrate of liquid crystal display according to an embodiment of the present invention includes steps S410 to S450.

Specifically, in the step S410, forming multiple thin-film transistors 200 on multiple pixel portions P of a substrate 100. Furthermore, after forming the multiple thin-film transistors 200, forming a first passivation layer 400 on the multiple thin-film transistors.

In step S420, forming multiple transparent electrodes 800 on the multiple pixel portions P. Wherein, the transparent electrode 800 is disposed on the pixel portion P where a white color filter 300W and/or a transparent color filter are to be formed.

In step S430, forming multiple color filters on the multiple pixel portions P. Here, forming a white color filter 300W or a transparent color filter on the pixel portion P provided with the transparent electrode 800, and other filters such as a red color filter 300R, a green color filter 300G and a blue color filter 300E are disposed on the pixel portion P where the transparent electrode 800 is not disposed. Furthermore, the pixel electrode 800 is used to apply a voltage to the white color filter 300W or the transparent color filter.

In the step S440, forming a black matrix 500 on the thin-film transistor 200 between the color filters. Furthermore, after the black matrix 500 is formed, forming a second passivation layer 600 on the black matrix 500 and the multiple color filters. It should be noted that when the black matrix is disposed on the color filter substrate opposite to the array substrate, the step S440 may be omitted.

In the step S450, forming a pixel electrode 700 connected to the thin-film transistor 200 on the multiple filters.

In summary, according to an embodiment of the present invention, the color of the white color filter and/or the transparent color filter made of the electrochromic material is changed by applying a voltage to increase the color gamut range of the liquid crystal display.

Although the invention has been shown and described with respect to specific embodiments, those skilled in the art will understand: without exceeding the principle and spirit of the present invention, the above embodiments can be improved, wherein the scope of the present invention is limited in the claims and the equivalents of the claims.

What is claimed is:

1. An array substrate for a liquid crystal display, wherein the array substrate comprises:
a substrate including multiple pixel portions;
multiple thin-film transistors disposed in the pixel portions;
multiple color filters, and the color filter is disposed in the pixel portion, wherein the multiple color filters includes a transparent color filter and/or a white color filter, colors of the transparent color filter and the white color filter are changed to a first color when a voltage is applied, and the first color is different from the other color filters except the transparent color filters and the white color filters in the multiple color filters;
multiple transparent electrodes deposed between the transparent color filters and/or the white color filters and the pixel portions; and
multiple pixel electrodes connected to the multiple thin-film transistors.

2. The array substrate according to claim 1, wherein the multiple color filters further includes a red color filter, a green color filter and a blue color filter.

3. The array substrate according to claim 2, wherein the first color is yellow or cyan.

4. The array substrate according to claim 1, wherein the array substrate further includes a black matrix located on the thin-film transistor and disposed between the color filters.

5. The array substrate according to claim 2, wherein the array substrate further includes a black matrix located on the thin-film transistor and disposed between the color filters.

6. The array substrate according to claim 3, wherein the array substrate further includes a black matrix located on the thin-film transistor and disposed between the color filters.

7. A manufacturing method for array substrate of liquid crystal display, comprising steps of:
forming multiple thin-film transistors on multiple pixel portions of a substrate;
forming multiple transparent electrodes on the multiple pixel portions;
forming multiple color filters on the multiple pixel portions, wherein the multiple color filters includes a transparent color filter and/or a white color filter, colors of the transparent color filter and the white color filter are changed to a first color when a voltage is applied, and the first color is different from the other color filters except the transparent color filters and the white color filters in the multiple color filters; and
forming a pixel electrode connected to the thin-film transistor on the multiple filters.

8. The manufacturing method according to claim 7, wherein the multiple color filters further includes a red color filter, a green color filter and a blue color filter.

9. The manufacturing method according to claim 8, wherein the first color is yellow or cyan.

10. The manufacturing method according to claim 7, wherein the manufacturing method further comprises a step of forming a black matrix on the thin-film transistor between the color filters.

11. The manufacturing method according to claim 8, wherein the manufacturing method further comprises a step of forming a black matrix on the thin-film transistor between the color filters.

12. The manufacturing method according to claim 9, wherein the manufacturing method further comprises a step of forming a black matrix on the thin-film transistor between the color filters.

13. A liquid crystal display, wherein the liquid crystal display includes an array substrate and a color filter substrate which are aligned and assembled, and the array substrate comprises:
a substrate including multiple pixel portions;
multiple thin-film transistors disposed in the pixel portions;
multiple color filters, and the color filter is disposed in the pixel portion, wherein the multiple color filters includes a transparent color filter and/or a white color filter, colors of the transparent color filter and the white color filter are changed to a first color when a voltage is applied, and the first color is different from the other color filters except the transparent color filters and the white color filters in the multiple color filters;
multiple transparent electrodes deposed between the transparent color filters and/or the white color filters and the pixel portions; and
multiple pixel electrodes connected to the multiple thin-film transistors.

14. The liquid crystal display according to claim 13, wherein the multiple color filters further includes a red color filter, a green color filter and a blue color filter.

15. The liquid crystal display according to claim 14, wherein the first color is yellow or cyan.

16. The liquid crystal display according to claim 13, wherein the array substrate further includes a black matrix located on the thin-film transistor and disposed between the color filters.

17. The liquid crystal display according to claim 14, wherein the array substrate further includes a black matrix located on the thin-film transistor and disposed between the color filters.

18. The liquid crystal display according to claim 15, wherein the array substrate further includes a black matrix located on the thin-film transistor and disposed between the color filters.
